(19) United States
(12) Patent Application Publication
(10) Pub. No.: US 2022/0176960 A1
(43) Pub. Date: Jun. 9, 2022

(54) VEHICULAR CONTROL SYSTEM WITH VEHICLE CONTROL BASED ON STORED TARGET OBJECT POSITION AND HEADING INFORMATION

(71) Applicant: Magna Electronics Inc., Auburn Hills, MI (US)

(72) Inventors: Arpit Awathe, Auburn Hills, MI (US); Tejas Murlidhar Varunjikar, Troy, MI (US)

(21) Appl. No.: 17/457,767

(22) Filed: Dec. 6, 2021

Related U.S. Application Data
(60) Provisional application No. 63/199,088, filed on Dec. 7, 2020.

(51) Int. Cl. B60W 30/165; B60W 10/20; G06V 20/58; G06V 20/56; G06T 7/70

(52) U.S. Cl. CPC B60W 30/165; B60W 10/20; G06V 20/58; G06V 20/588; G06T 7/70; G06T 2207/30256; B60W 2420/52; B60W 2540/18; B60W 2552/53; B60W 2554/802; G06T 2207/30241; B60W 2510/202

(57) ABSTRACT

A vehicular driving assist system includes a sensor disposed at a vehicle and sensing forward of the equipped vehicle. With the equipped vehicle traveling along a traffic lane of a road, the system, responsive to processing of sensor data captured by the sensor, determines a leading vehicle traveling along the traffic lane ahead of the equipped vehicle. The system determines position and heading information of the leading vehicle relative to the equipped vehicle. As the equipped vehicle approaches locations that correspond with the determined position and heading information of the leading vehicle, the system adapts the position and heading information of the leading vehicle to the current location and heading of the equipped vehicle and controls lateral movement of the equipped vehicle to follow the leading vehicle in and long the traffic lane of the road.

### CROSS REFERENCE TO RELATED APPLICATION

The present application claims the filing benefits of U.S. provisional application Ser. No. 63/199,088, filed Dec. 7, 2020, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

Implementations herein provide a vehicular driving assist system that includes a sensor disposed at a vehicle equipped with the vehicular driving assist system. The sensor has a field of sensing at least forward of the vehicle and captures sensor data. The system includes an electronic control unit (ECU) including electronic circuitry and associated software. The electronic circuitry of the ECU includes a data processor for processing sensor data captured by the sensor to detect presence of at least one other vehicle in the field of sensing of the sensor. With the equipped vehicle traveling in and along a traffic lane of a road, the vehicular driving assist system, responsive to processing by the data processor of sensor data captured by the sensor, determines a leading vehicle traveling in and along the traffic lane ahead of the equipped vehicle. The vehicular driving assist system, responsive to processing by the data processor of sensor data captured by the sensor, determines pose information of the leading vehicle relative to the equipped vehicle at locations along the traffic lane of the road while the leading vehicle and the equipped vehicle are traveling in and along the traffic lane of the road. The pose information includes (i) position of the leading vehicle relative to the equipped vehicle at a location along the traffic lane of the road and (ii) heading of the leading vehicle relative to the equipped vehicle at that location along the traffic lane of the road. While the equipped vehicle travels in and along the traffic lane and approaches a location that corresponds with one of the locations at which respective pose information is determined, the vehicular driving assist system adapts the respective pose information to the equipped vehicle's current location and current heading and controls lateral movement of the equipped vehicle so that the equipped vehicle follows the leading vehicle in and along the traffic lane of the road.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a flowchart showing the object following algorithm;

FIG. 3 is a flowchart showing details of the object path estimation process of FIG. 2;

FIG. 4 is a plan view schematic showing the vehicle of FIG. 1 following a target vehicle along a curved road;

FIG. 5 is another plan view schematic showing a reference line between the vehicle of FIG. 1 and the target vehicle at a given time;

FIG. 6 is another plan view schematic showing a reference line using current and previous target vehicle position data;

FIG. 7 is another plan view schematic showing use of down-sampling of the target vehicle positions to generate a path for the vehicle of FIG. 1 to follow;

FIG. 8 is another plan view schematic showing the transformation of the target vehicle positions with the motion of the vehicle of FIG. 1; and

FIG. 9 shows equations used to generate the subject vehicle path.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

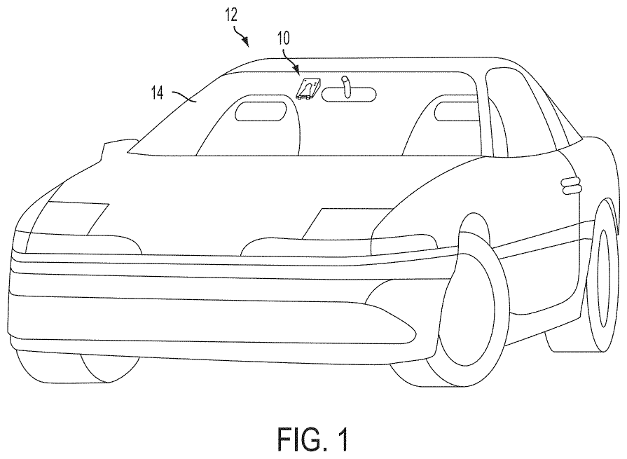

Referring now to the drawings and the illustrative embodiments depicted therein, a vision system 10 for a vehicle 12 includes at least one exterior viewing imaging sensor or camera, such as a forward viewing imaging sensor or camera, which may be disposed at and behind the windshield 14 of the vehicle and viewing forward through the windshield so as to capture image data representative of the scene occurring forward of the vehicle (FIG. 1). Optionally, the system may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. The camera or cameras each include a lens for focusing images at or onto an imaging array or imaging plane or imager of the camera. The forward viewing camera disposed at the windshield of the vehicle views through the windshield and forward of the vehicle, such as for a machine vision system (such as for traffic sign recognition, headlamp control, pedestrian detection, collision avoidance, lane marker detection and/or the like). The vision system 10 includes a control or electronic control unit (ECU) having electronic circuitry and associated software, with the electronic circuitry including a data processor or image processor that is operable to process image data captured by the camera or cameras, whereby the ECU may detect or determine presence of objects or the like and/or the system provide displayed images at a display device for viewing by the driver of the vehicle. The data transfer or signal communication from the camera to the ECU may comprise any suitable data or communication link, such as a vehicle network bus or the like of the equipped vehicle.

Advanced Driver Assistance Systems (ADAS) obtain information of an environment surrounding a vehicle through different sensors. This information is used by various features (e.g. adaptive cruise control (ACC), lane centering, lane keeping assist, etc.) to assist the driver while driving a vehicle (or to provide autonomous control of the vehicle). The features like lane keeping assist or lane centering typically use information from the windshield-mounted forward viewing camera sensor, including traffic lane marker information, to provide lateral control or steering of the vehicle. However, there are situations in which the traffic lanes or traffic lane markers are not clearly visible (faded paint, covered with snow, high reflection from sun, etc.) or are limited in view range (e.g., in a traffic jam situation where enough length of a traffic lane marker is not visible for performing lateral control). In such cases, these driving assist systems or features can use object information, such as a closest-in-path-vehicle (CIPV), to follow that object or target vehicle using lateral control. That is, the vehicle can follow a path traveled by a vehicle driving in the same lane in front of the equipped vehicle.

Implementations herein include a driving assist system that uses an algorithm to provide lateral control of the equipped vehicle by using information about objects (e.g., other vehicles) in the surroundings of the equipped vehicle so that the system can follow a target object/leading vehicle along the road in front of the equipped vehicle. This feature assists the driver of the equipped vehicle to keep the equipped vehicle traveling along a traffic lane and following a leading target vehicle in that traffic lane ahead of the equipped vehicle even when traffic lane markers are not visible or otherwise useful for lateral vehicle control.

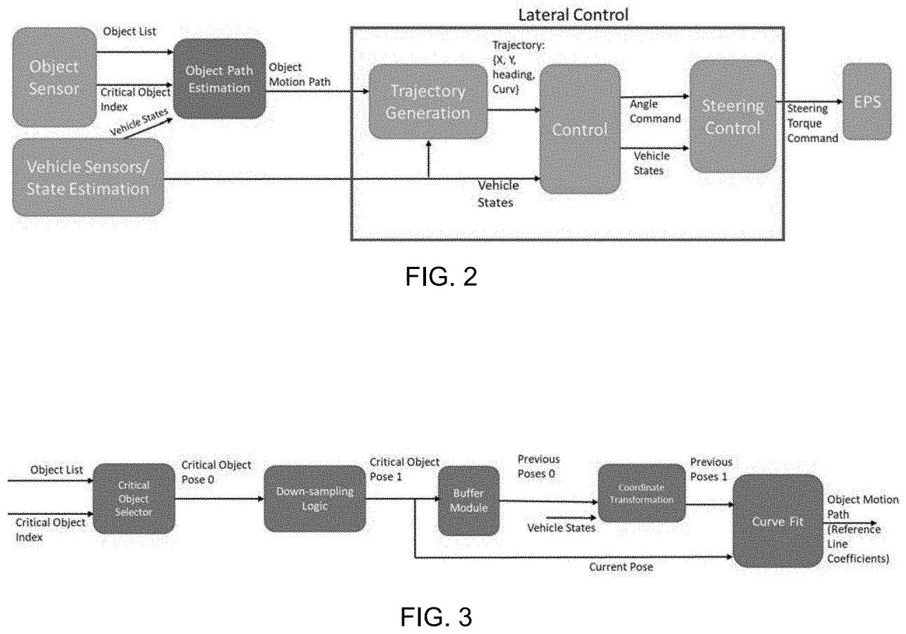

As shown in FIG. 2, the object following system includes one or more object sensors, such as, for example, radar sensors and/or lidar sensors and/or cameras that view or sense forward of the vehicle. The object sensor(s) are used to get accurate information of the objects surrounding the vehicle including the objects in front of the ego or host or equipped vehicle. Multiple sensors (e.g., a camera sensor and a radar sensor) may be controlled by the same ECU or separate ECUs.

The system also includes an object path estimation block or element or feature. The object list information obtained is with respect to the ego or equipped vehicle. For example, the object path estimation is based on an object list and critical object index provided by the object sensor(s) and vehicle state information from vehicle sensors and/or a vehicle state estimator (e.g., vehicle speed, yaw rate, acceleration, etc.). The object path estimation block stores a current object position and a previous object position (e.g., a leading vehicle) with respect to the equipped vehicle and continuously updates the object path estimation based on the equipped vehicle's motion (i.e., longitudinal and lateral movement). The system includes logic that is configured such that only certain points that are either equal in length or time are stored in a buffer. The algorithm uses this data and creates an object path, i.e., a polynomial equation which represents the path for the equipped vehicle to follow. A function is generated and is used to fit these object position points to obtain or generate a polynomial coefficient of the object path. The vehicle state estimator includes vehicle control modules/algorithms that provide vehicle state information (of the equipped vehicle), such as vehicle speed, yaw rate, etc.

The object path estimation (i.e., the object motion path) and the vehicle state estimator (i.e., vehicle state) output to a lateral control module. The lateral control module uses the object motion path to laterally control the equipped vehicle to follow the generated or provided object motion path. The lateral control includes a trajectory generation module that calculates a desired and/or current trajectory of the vehicle (e.g., the x-y position of the vehicle relative to the leading vehicle, heading, curve, etc.). A control receives the vehicle states and the vehicle trajectory. Using the desired/current vehicle trajectory, and current vehicle states, the control software module generates a steer command for a steering system of the equipped vehicle that will cause the equipped vehicle to follow the desired trajectory. The steer command may include a steering wheel angle, a steering angle or a curvature or other suitable command or control output to cause the vehicle to follow the desired trajectory. The steering control receives the steer angle command and converts it to a steering torque command, which is provided to, for example, the electric power steering (EPS) of the equipped vehicle. The EPS system (hardware and/or software) applies the steering torque command to enable the ADAS feature for lateral control or steering of the equipped vehicle.

Referring now to FIG. 3, the object path estimation block of FIG. 2 is shown in more detail, and here includes a critical object selector, down-sampling logic, a buffer module, a coordinate transformation module and a curve fitting module. As used herein, the term pose refers to collective information of position as well as orientation (heading angle) of an object or vehicle (i.e., the pose information or data includes the x, y position of the leading vehicle relative to the equipped vehicle and the 8 angle orientation or heading angle of the leading vehicle relative to the equipped vehicle). The reference line is the ideal geometric path which needs to be followed by the equipped vehicle. The equipped vehicle may be surrounded by multiple objects (e.g., other vehicles), and the target object or target vehicle (i.e., the leading vehicle) is the most critical object/vehicle that the equipped vehicle should follow (and is another vehicle traveling in the same lane ahead of the equipped vehicle).

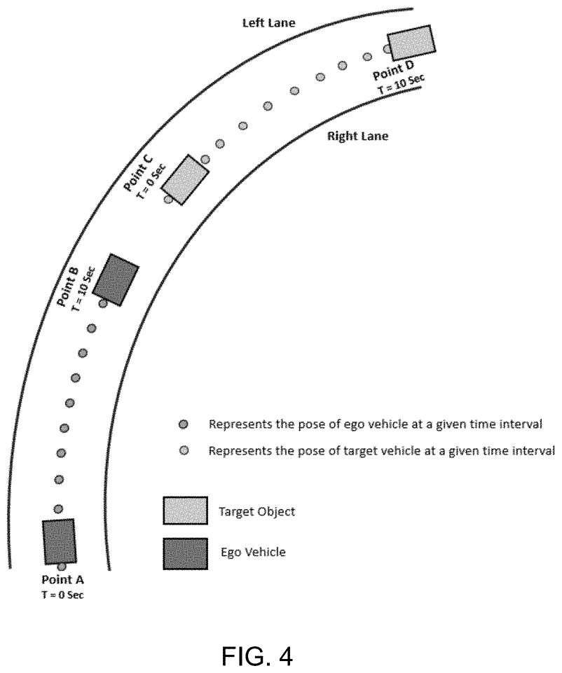

The equipped vehicle follows the target object which can be specifically elaborated as following the same path which the target object has taken. As shown in FIG. 4, at time T=0 sec, the ego or equipped vehicle is at point A while the target vehicle is at Point C, and after 10 sec the equipped vehicle has reached point B whereas the target vehicle has reached point D. While traveling from point A to point B, the equipped vehicle passes through all the poses marked between points A and B (i.e., the equipped vehicle matches the position and orientation of the target vehicle when the target vehicle passed through the same location), and the target vehicle passes through all the poses marked between points C and D. At T=10 seconds, if the equipped vehicle decides to follow the target vehicle then ideally it should follow the path which the target vehicle has taken, i.e., the ego or subject vehicle should reach point D while ensuring that it passes through or over all the poses or points that the target vehicle went through.

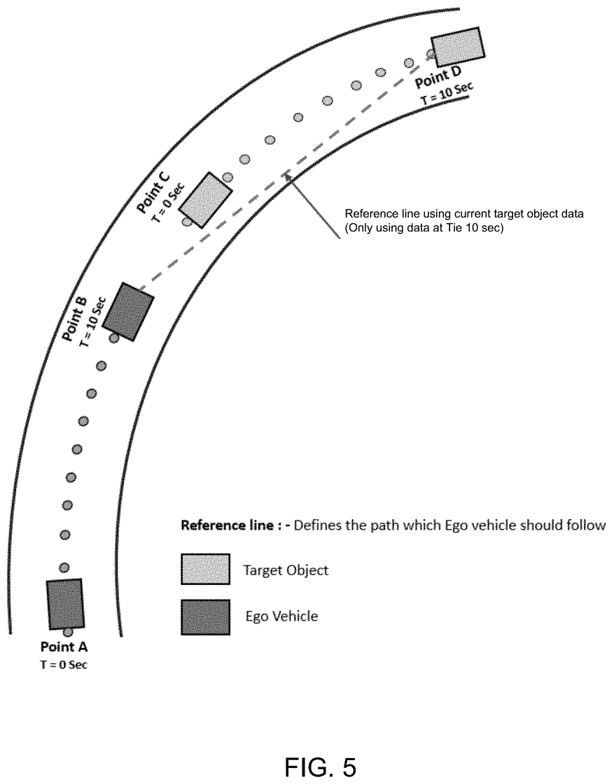

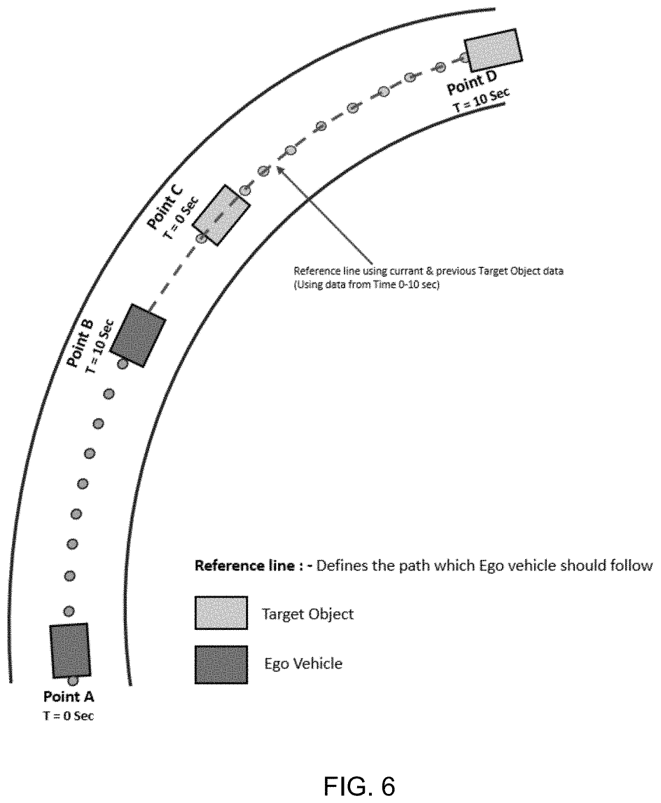

For the equipped vehicle, the system only has the current target object pose with respect to the equipped vehicle, so when the equipped vehicle is at point A, the system has the target vehicle pose information of point C, and when the equipped vehicle is at point B, then the system has the target vehicle information of point D. Thus, when the equipped vehicle is at point B, if the equipped vehicle is to follow the target object or vehicle that is at point D, then using only the current information, the system would have a reference line as illustrated in FIG. 5. However, this reference line cuts the corners of the curve of the traffic lane and it would be dangerous for the equipped vehicle to follow the target vehicle using that path (i.e., a direct linear path). However, the system uses the previous pose information (including the heading of the target vehicle) of the target vehicle to generate a reference line as shown in FIG. 6, which connects all the previous poses which the target object has followed.

The object path estimation module functions to determine the critical object (i.e., the target vehicle) that the equipped vehicle is to follow and tracks the target vehicle along its path ahead of the equipped vehicle. The critical object selector uses the vehicle sensors, such as camera or radar, or a sensor fusion module, which provide information about several objects present in vicinity of the vehicle as an object list. A critical object to follow is selected from this list. The information about the index of this critical object may come from sensor fusion/camera sensor/radar sensor/other sensor/other ADAS modules, such as ACC, etc. In all cases, a closest-in-path-vehicle (CIPV) object is usually selected (i.e., the vehicle that the system determines is closest to driving along the same path or traffic lane as the equipped vehicle), and its index is received by the critical object selector, which outputs that object's pose to the down-sampling logic.

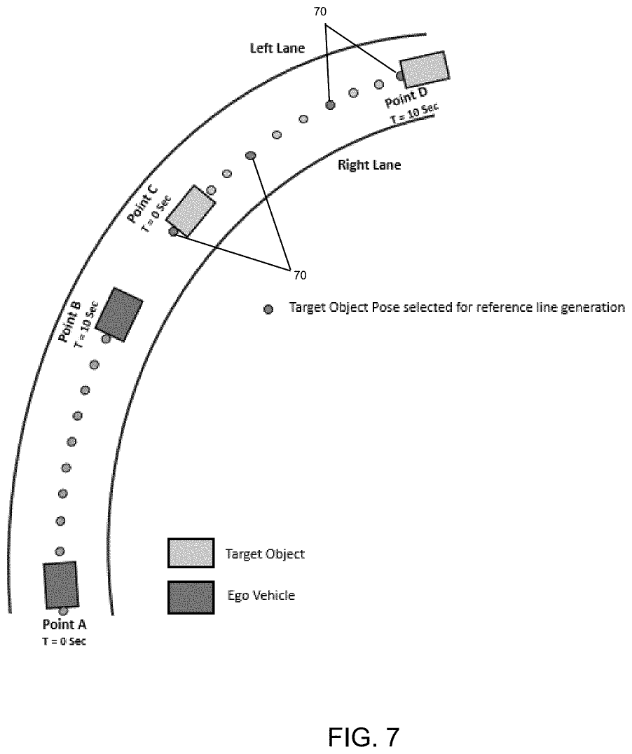

The down-sampling logic receives the target object's pose information or data. To estimate the reference line, the system stores the previous poses or pose data of the target object (relative to the equipped vehicle), and the algorithm creates a buffer data and stores CM′ number of poses which includes the current and previous poses of the target object. These CM′ poses are selected/down-sampled based on the criteria that they all are separated by an equal threshold distance. In FIG. 7, it is shown that from point C to point D the system selects only four points 70 (shown as darker points along the path between point C and point D). These selected points 70 will be used for the reference line estimation.

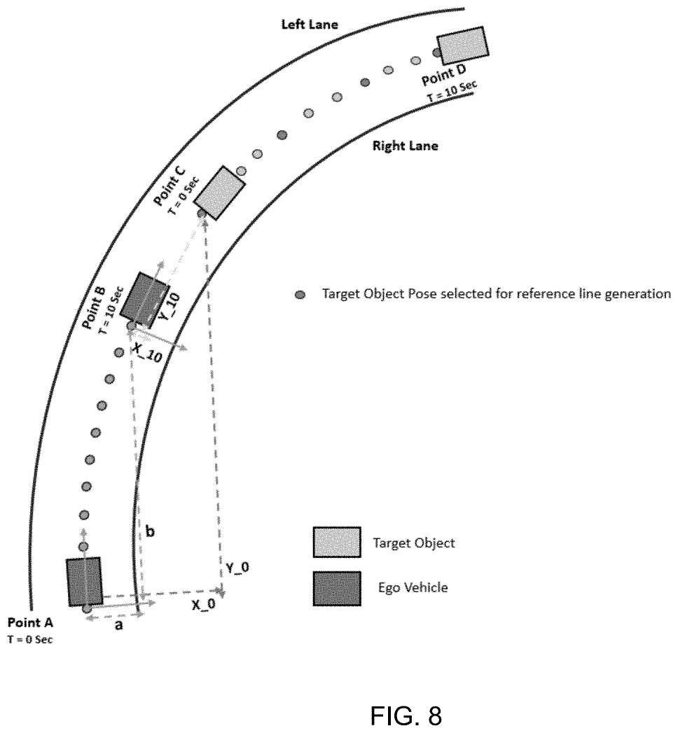

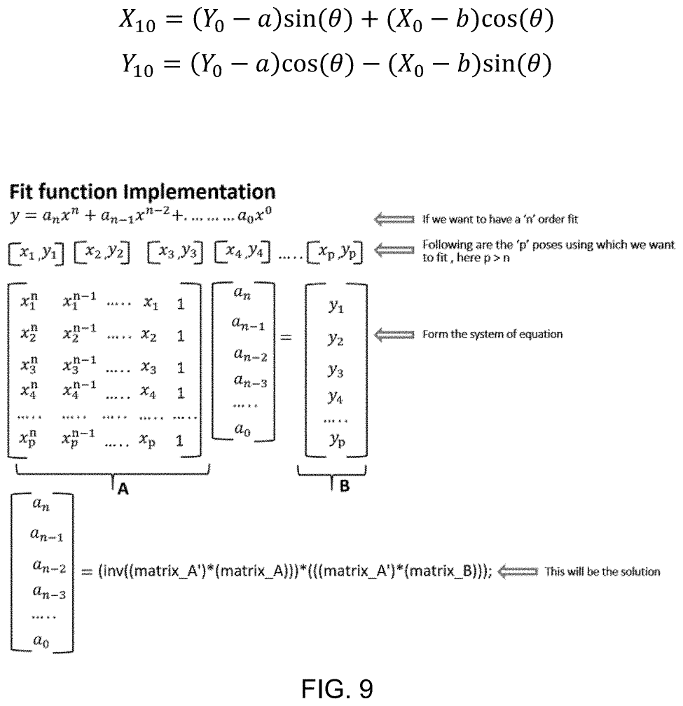

The buffer module and coordinate transformation transforms the selected points into a fitted curve that represents the trajectory that the equipped vehicle is to follow. The current object pose information is with respect to the equipped vehicle current location, while all the previous poses stored in the buffer are transformed with the equipped vehicle's motion (i.e., each pose data point is transformed to the coordinate system of the current position and orientation of the equipped vehicle as the equipped vehicle travels along the traffic lane of the road). This is important as all the poses stored in the buffer should be with respect to the equipped vehicle's current position. In FIG. 8, it is shown that when the equipped vehicle is at point A where it has the information of point C which is (X_0, Y_0) but when the vehicle has reached point B then the system needs the information of point C with respect to point B, i.e., the system needs (X_10, Y_10). In this situation, the transformation equations of FIG. 9 can be used.

Once the buffer has all the CM′ points, then those CM′ points can be fitted and geometrically represented as a polynomial of degree ‘n’. In FIG. 9, it is shown that the system may use ID′ number of poses to get a polynomial of degree ‘n’. It is noted that the polynomial fit is one of the approaches that can be used, and other embodiments are also possible using the systems disclosed herein.

Thus, the ADAS feature can follow a target object by generating a steering torque command based on object information coming from sensors. The object reference path estimation module generates a reference line representing the leading object path. The lateral control module uses the reference line information to generate a steering torque command.

The object reference path estimation module includes the critical object selector that outputs pose information or data of the critical object. The down-sampling logic decides the pose information that is to be included in the buffer. The buffer module stores multiple pose information received from the down-sampling logic. The coordinate transformation converts the pose information to the current equipped vehicle's coordinate system of reference. The curve-fit function outputs the reference line. For example, the curve-fit function may output coefficients for a polynomial (e.g., cubic).

Thus, as the equipped vehicle travels along the traffic lane of the road, the system continuously or episodically transforms stored position and heading information of a target vehicle to be relative to the current position and heading of the equipped vehicle. Although discussed above as providing lateral control of the equipped vehicle responsive to the transformed position and heading information of the target vehicle, the system may also determine when the target vehicle is increasing or decreasing speed relative to the current speed of the equipped vehicle, such as by determining, for example, that the position information of the target vehicle is representative of points along the traffic lane that are closer together for a given period of time (indicating that the target vehicle is slowing down). The system may control acceleration or deceleration of the equipped vehicle based on the transformed position information of the target vehicle relative to the equipped vehicle.

For autonomous vehicles suitable for deployment with the system of the present invention, an occupant of the vehicle may, under particular circumstances, be desired or required to take over operation/control of the vehicle and drive the vehicle so as to avoid potential hazard for as long as the autonomous system relinquishes such control or driving. Such occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2015-0327398; US-2015-0015713; US-2014-0160284; US-2014-0226012 and/or US-2009-0295181, which are all hereby incorporated herein by reference in their entireties.

The system may utilize sensors, such as radar or lidar sensors or the like, to detect presence of and/or range to other vehicles and objects at the intersection. The sensing system may utilize aspects of the systems described in U.S. Pat. Nos. 9,753,121; 9,689,967; 9,599,702; 9,575,160; 9,146,898; 9,036,026; 8,027,029; 8,013,780; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a sensor disposed at a vehicle equipped with the vehicular driving assist system and having a field of sensing at least forward of the vehicle, the sensor capturing sensor data;
an electronic control unit (ECU) comprising electronic circuitry and associated software;
wherein the electronic circuitry of the ECU comprises a data processor for processing sensor data captured by the sensor to detect presence of at least one other vehicle in the field of sensing of the sensor;
wherein, with the equipped vehicle traveling in and along a traffic lane of a road, the vehicular driving assist system, responsive to processing by the data processor of sensor data captured by the sensor, determines a leading vehicle traveling in and along the traffic lane ahead of the equipped vehicle;
wherein the vehicular driving assist system, responsive to processing by the data processor of sensor data captured by the sensor, determines pose information of the leading vehicle relative to the equipped vehicle at locations along the traffic lane of the road while the leading vehicle and the equipped vehicle are traveling in and along the traffic lane of the road, and wherein the pose information comprises (i) position of the leading vehicle relative to the equipped vehicle at a location along the traffic lane of the road and (ii) heading of the leading vehicle relative to the equipped vehicle at that location along the traffic lane of the road; and
wherein, while the equipped vehicle travels in and along the traffic lane and approaches a location that corresponds with one of the locations at which respective pose information is determined, the vehicular driving assist system adapts the respective pose information to the equipped vehicle's current location and current heading and controls lateral movement of the equipped vehicle so that the equipped vehicle follows the leading vehicle in and along the traffic lane of the road.

2. The vehicular driving assist system of claim 1, wherein the sensor comprises a forward viewing camera disposed at an in-cabin side of a windshield of the equipped vehicle.

3. The vehicular driving assist system of claim 2, wherein the forward viewing camera comprises a CMOS imaging array, and wherein the CMOS imaging array comprises at least one million photosensors arranged in rows and columns.

4. The vehicular driving assist system of claim 1, wherein the sensor comprises a forward sensing radar sensor.

5. The vehicular driving assist system of claim 1, wherein the sensor comprises a forward sensing lidar sensor.

6. The vehicular driving assist system of claim 1, wherein the vehicular driving assist system selects a set of pose information of the leading vehicle relative to the equipped vehicle for determining a trajectory for the equipped vehicle to follow along the traffic lane of the road.

7. The vehicular driving assist system of claim 6, wherein the determined trajectory for the equipped vehicle to follow along the traffic lane of the road comprises a polynomial fitted to locations of the pose information.

8. The vehicular driving assist system of claim 6, wherein the selected set of pose information includes locations spaced apart by an equal selected distance along the traffic lane of the road.

9. The vehicular driving assist system of claim 1, wherein the vehicular driving assist system operates to determine the pose information of the leading vehicle relative to the equipped vehicle responsive to determination that lane markers for the traffic lane are not discernible by a lane marker detection system of the equipped vehicle.

10. The vehicular driving assist system of claim 1, wherein the vehicular driving assist system, when controlling the lateral movement of the vehicle, calculates a steering angle command or a steering torque command.

11. The vehicular driving assist system of claim 1, wherein the vehicular driving assist system, responsive to processing by the data processor of sensor data captured by the sensor, determines a plurality of other vehicles ahead of the equipped vehicle, and wherein the vehicular driving assist system selects the leading vehicle from the plurality of other vehicles.

12. The vehicular driving assist system of claim 11, wherein the vehicular driving assist system selects the leading vehicle based on a closest-in-path analysis.

13. A vehicular driving assist system, the vehicular driving assist system comprising:
a camera disposed at a vehicle equipped with the vehicular driving assist system and having a field of view at least forward of the vehicle, the camera capturing image data, wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor for processing image data captured by the camera to detect presence of at least one other vehicle in the field of view of the camera;
wherein, with the equipped vehicle traveling in and along a traffic lane of a road, the vehicular driving assist system, responsive to processing by the image processor of image data captured by the camera, determines a leading vehicle traveling in and along the traffic lane ahead of the equipped vehicle;
wherein the vehicular driving assist system, responsive to processing by the image processor of image data captured by the camera, determines pose information of the leading vehicle relative to the equipped vehicle at locations along the traffic lane of the road while the leading vehicle and the equipped vehicle are traveling in and along the traffic lane of the road, and wherein the pose information comprises (i) position of the leading vehicle relative to the equipped vehicle at a location along the traffic lane of the road and (ii) heading of the leading vehicle relative to the equipped vehicle at that location along the traffic lane of the road;
wherein, while the equipped vehicle travels in and along the traffic lane and approaches a location that corresponds with one of the locations at which respective pose information is determined, the vehicular driving assist system adapts the respective pose information to the equipped vehicle's current location and current heading to determine a trajectory to follow the leading vehicle in and along the traffic lane of the road; and
wherein the vehicular driving assist system controls lateral movement of the equipped vehicle using the determined trajectory so that the equipped vehicle follows the leading vehicle in and along the traffic lane of the road.

14. The vehicular driving assist system of claim 13, wherein the camera is disposed at an in-cabin side of a windshield of the equipped vehicle.

15. The vehicular driving assist system of claim 13, wherein the determined trajectory for the equipped vehicle to follow along the traffic lane of the road comprises a polynomial fitted to locations of the pose information.

16. The vehicular driving assist system of claim 13, wherein the vehicular driving assist system selects a set of pose information of the leading vehicle relative to the equipped vehicle to determine the trajectory for the equipped vehicle to follow along the traffic lane of the road.

17. The vehicular driving assist system of claim 16, wherein the selected set of pose information includes locations spaced apart by an equal selected distance along the traffic lane of the road.

18. The vehicular driving assist system of claim 13, wherein the vehicular driving assist system operates to determine the pose information of the leading vehicle relative to the equipped vehicle responsive to determination that lane markers for the traffic lane are not discernible by a lane marker detection system of the equipped vehicle.

19. A vehicular driving assist system, the vehicular driving assist system comprising:
a radar sensor disposed at a vehicle equipped with the vehicular driving assist system and having a field of sensing at least forward of the vehicle, the radar sensor capturing sensor data;
an electronic control unit (ECU) comprising electronic circuitry and associated software;
wherein the electronic circuitry of the ECU comprises a data processor for processing sensor data captured by the radar sensor to detect presence of at least one other vehicle in the field of sensing of the radar sensor;
wherein, with the equipped vehicle traveling in and along a traffic lane of a road, the vehicular driving assist system, responsive to processing by the data processor of sensor data captured by the radar sensor, determines, from a plurality of detected other vehicles, a leading vehicle traveling in and along the traffic lane ahead of the equipped vehicle;
wherein the vehicular driving assist system, responsive to processing by the data processor of sensor data captured by the radar sensor, determines pose information of the leading vehicle relative to the equipped vehicle at locations along the traffic lane of the road while the leading vehicle and the equipped vehicle are traveling in and along the traffic lane of the road, and wherein the pose information comprises (i) position of the leading vehicle relative to the equipped vehicle at a location along the traffic lane of the road and (ii) heading of the leading vehicle relative to the equipped vehicle at that location along the traffic lane of the road; and
wherein, while the equipped vehicle travels in and along the traffic lane and approaches a location that corresponds with one of the locations at which respective pose information is determined, the vehicular driving assist system adapts the respective pose information to the equipped vehicle's current location and current heading and controls lateral movement of the equipped vehicle so that the equipped vehicle follows the leading vehicle in and along the traffic lane of the road.

20. The vehicular driving assist system of claim 19, wherein the vehicular driving assist system, when controlling the lateral movement of the vehicle, calculates a steering angle command or a steering torque command.

21. The vehicular driving assist system of claim 19, wherein the vehicular driving assist system determines the leading vehicle from the plurality of detected other vehicles based on a closest-in-path analysis.

22. The vehicular driving assist system of claim 19, wherein the vehicular driving assist system operates to determine the pose information of the leading vehicle relative to the equipped vehicle responsive to determination that lane markers for the traffic lane are not discernible by a lane marker detection system of the equipped vehicle.
